(19) United States
(12) Patent Application Publication
(10) Pub. No.: US 2006/0050089 A1
(43) Pub. Date: Mar. 9, 2006

(54) Method and apparatus for selecting pixels to write to a buffer when creating an enlarged image

(76) Inventor: Atousa Soroushi, North Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/936,987

(22) Filed: Sep. 9, 2004

(51) Int. Cl. G09G 5/00

(52) U.S. Cl. 345/660

(57) ABSTRACT

The invention is directed to a method and apparatus for selecting pixels to write to a buffer when creating an enlarged image. The apparatus includes a display pipe for buffering a row of pixels to be rendered in a display space, and a controller for writing display pixels to the display pipe. The controller is adapted for determining which pixels in a row of pixels are non-display pixels so that the controller does not write the non-display pixels to the display pipe. Preferably, the apparatus includes a memory for storing the original image. The method includes the steps of determining which pixels in a row of pixels are non-display pixels; and forwarding the display pixels for rendering in the display space so that the non-display pixels are not forwarded for rendering in the display space.

### FIELD OF INVENTION

The invention relates to digital image processing. More particularly, the invention is directed to a method and apparatus for selecting pixels to write to a buffer when creating an enlarged image.

### BACKGROUND

Digital images have become commonplace. They are displayed on the display screens employed in computer systems and televisions, such as CRTs and LCDs. They are printed as hard copy on media with devices like laser and inkjet printers.

Digital images are comprised of arrays of pixels. A pixel is a small, discrete element in the display screen that can be illuminated with a particular color and degree of brightness. The term pixel is also used to refer to the datum that define the color and intensity of the physical pixels in display and hard copy rendering devices.

Digital devices can be used to zoom in or out on an object in a digital image. A camera, digital television, cellular telephone, personal digital assistant, personal computer, and other digital devices enlarge a selected portion of the original image by creating a new image from the selected portion.

The enlarged image is made up of pixels from the selected portion. Pixels from the selected portion appear at least once and may appear more than once in the enlarged image. Pixels that are not in the selected portion do not appear in the enlarged image.

Typically, the original image is stored in a memory. A portion of the original image, such as a row of pixels, are fetched from the memory and written to a buffer. The pixels are transmitted from the buffer to a display device. The buffer is periodically replenished with another portion of image data.

When an entire original image is displayed in its original size, all of the pixels for a row are fetched from the memory, written to the buffer, and transmitted to the display. This process is repeated for each row of pixels in the original image.

When a selected portion of an original image is displayed as an enlarged image, again all of the pixels for a row are fetched from the memory, written to the buffer, and transmitted to the display. This process is repeated, however, only for each row of pixels in the original image that is to appear in the enlarged image.

A problem arises from the fact that those pixels in a row that are not in the selected portion do not appear in the enlarged image. These non-display pixels are fetched from memory, written to the buffer, but not transmitted to the display. This increases the number of memory fetches and writes to the buffer, wasting memory bandwidth and power.

Accordingly, there is a need for a method and apparatus for selecting pixels to write to a buffer when creating an enlarged image.

### SUMMARY

The invention is directed to a method and apparatus for selecting pixels to write to a buffer when creating an enlarged image. Preferably, the invention is employed in a graphics controller, and the principles of the invention are illustrated in this context in this specification. However, the method and apparatus according to the invention may be used in other contexts.

The apparatus creates an enlarged image from an original image. The enlarged image is suitable for rendering in a display space, that is, as a particular number of rows and columns of pixels. The original image includes display pixels that will be rendered in the enlarged image. The original image also includes non-display pixels that will not be rendered in the enlarged image.

The apparatus includes a display pipe and a controller. The display pipe is for buffering a row of pixels to be rendered in the display space, and the controller is for writing display pixels to the display pipe. The controller determines which pixels in a row of pixels are non-display pixels. The controller does not write the non-display pixels to the display pipe. Preferably, the apparatus also includes a display buffer for storing the original image and a pixel fetching apparatus for fetching display pixels from the display buffer.

The invention is also directed to a computer system that includes an apparatus for selecting pixels to write to a buffer when creating an enlarged image according to the principles of the invention.

The method includes the step of determining which pixels in a row of pixels are non-display pixels, and the step of forwarding the display pixels for rendering in the display space so that the non-display pixels are not forwarded for rendering in the display space.

The invention is also directed to a machine readable medium. The medium is embodies a program of instructions that may be executed by a machine. When executed, the machine performs a method for selecting pixels to write to a buffer when creating an enlarged image according to the principles of the invention.

This summary is provided as a means of generally determining what follows in the drawings and detailed description and is not intended to limit the scope of the invention. Objects, features and advantages of the invention will be more readily understood upon consideration of the following detailed description taken in conjunction with the accompanying drawings.

### DESCRIPTION OF THE DRAWINGS

FIG. 1 is a representation of an original digital image.

FIG. 2 is a diagram of a selected portion of the original image of FIG. 1 and an enlarged image.

FIG. 3 is a block diagram of a prior art computer system for displaying digital images.

FIG. 4 is a diagram of a graphics controller including a vertical enlarger and a horizontal enlarger, which illustrates the problem solved by invention.

FIG. 5 illustrates an example of the rows fetched by the vertical enlarger of FIG. 4.

FIG. 6 illustrates an example of the columns fetched by the horizontal enlarger of FIG. 4.

FIG. 7 is a representation of an exemplary enlarged image created by the graphics controller of FIG. 4.

FIG. 8 is a block diagram of a graphics controller including a column selector according to the invention.

FIG. 9 is a block diagram illustrating the column selector of FIG. 8, which includes a pixel number calculator.

FIG. 10 is a representation of exemplary display and non-display pixels in a digital image.

FIG. 11 is a block diagram illustrating an alternative preferred pixel number calculator.

### DETAILED DESCRIPTION OF A PREFERRED EMBODIMENT

The invention is directed to a method and apparatus for selecting pixels to write to a buffer when creating an enlarged image. This specification describes the present preferred embodiments of the invention, examples of which are illustrated in the accompanying drawings. Whenever possible, the same reference numbers are used in the drawings and specification to refer to the same or like parts, blocks, and steps.

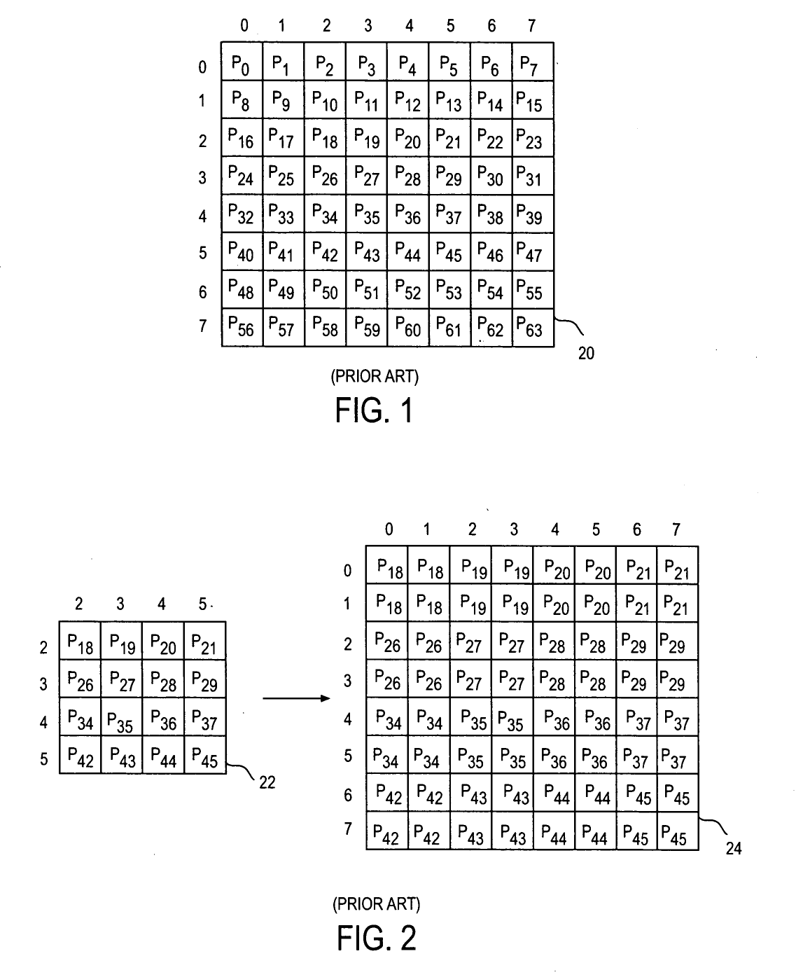

FIG. 1 is a representation of a digital image 20. FIG. 1 shows that digital images are comprised of arrays or matrices of pixels. The column and row coordinates of pixel locations of the image 20 are given by the numbers to the top and side of the image 20. The image 20 has 64 pixels: P₀ to P₆₃. For example, pixel P₃₅ is mapped into the pixel location defined by column 3 and row 4, that is, (column, row)=(3, 4).

FIG. 2 illustrates creating an enlarged image by doubling the image data. A desired portion of pixels from the original image 20 are selected. The selected pixels are designated by reference number 22. Each selected pixel together with copies of the pixel appear in an enlarged image 24. For example, pixel P₃₅ is copied or replicated three times so that it appears in the image 24 four times, twice horizontally and twice vertically, as the original and three pixel copies. In the enlarged image 24, pixel P₃₅ is mapped into the pixel locations (2, 4), (3, 4), (2, 5), and (3, 5).

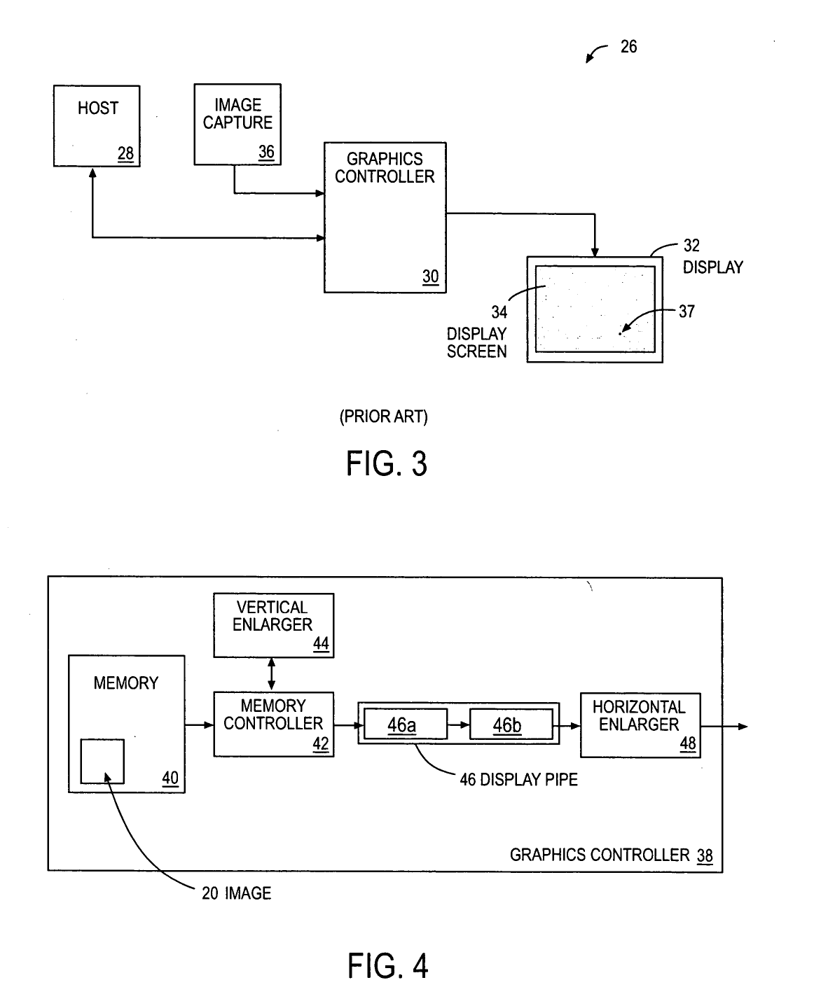

FIG. 3 is a block diagram of a prior art computer system 26. The computer system 26 is one preferred context for the invention. The system includes a host 28, a graphics controller 30, and a display device 32, which has a display screen 34. The system 26 also includes an image capture device 36. Typically, the host 28 is a CPU and the image capture device 36 is a camera. Image data are transmitted from the host 28 and the image capture device 36 to the graphics controller 30. The image data are then transmitted from the graphics controller 30 to the display device 32 for display as an image on the display screen 34. While the display device 32 is commonly an LCD panel, it may be any device capable of rendering image data, including CRT, OLED, or other types of display devices, as well as hard copy rendering devices, such as printers.

Pixels are typically mapped into locations in the display screen 34 in the same manner as they are mapped into an image. Like the image 20, the pixels in the display screen 34 are defined by a plurality of columns “c” and rows “r.” A particular number of the columns and rows in the display screen 34 is referred to as a “display space” in this specification. (Display space may also refer to a particular number of the columns and rows of the print area of a printer.) As with the image 20, each intersection of a row and a column defines a pixel location 37 on the screen 34.

Referring to FIG. 4, a graphics controller 38 illustrating the problem solved by invention is shown. The graphics controller 38 includes a memory 40, a memory controller 42, a vertical enlarger 44, a display pipe 46, and a horizontal enlarger 48.

The memory 40 may be a memory of any type and is typically, though not necessarily, of a size larger than required to store the original image. Image data received from the host 28 or image capture device 36, such as pixels defining the image 20, are stored in the memory 40. The image data for an image may be stored in raster or in any other order. The memory 40, however, is adapted to permit data to be fetched in a raster sequence. A raster sequence proceeds from left to right in each line, and from the top line to the bottom line in an image. While image data need not be stored in raster order, it will be assumed in the discussion that follows that the image data are stored in the memory 40 in raster order.

The memory controller 42 controls access to the memory 40. When two or more modules or devices request access to the memory 40 at the same time, the memory controller arbitrates access to the memory. The memory 40 is accessed in synchronicity with a memory clock MCLK.

The graphics controller 38 also includes a display pipe 46. After image data are stored in the memory 40, the data are fetched for transmission to the display device 32. The memory 40, however, is commonly accessed by devices and modules other than a module for fetching image data. To prevent the display device 32 from being starved of image data while another device or module is accessing the memory 40, portions of the image data are read from the memory and written to a buffer from which the data is then transmitted to the display device 32. In this specification, this buffer is referred to as a “display pipe,” and in the graphics controller 38 the buffer is the display pipe 46.

Preferably, the display pipe 46 is a FIFO (first-in-first-out) memory, though this is not essential. The display pipe 46 may be provided in two portions 46a and 46b connected in series. An upstream, first portion 46a of the pipe is clocked at the memory clock rate MCLK. The downstream, second portion 46b of the pipe is clocked at a display clock rate PCLK, which is appropriate for writing the data to the display device 32. Image data are written to the display pipe 46 at the memory clock rate, and read from the pipe at the display clock rate.

Typically, MCLK is a higher frequency than PCLK. The dual frequency data transfer capability allows the display pipe 46 to be rapidly filled with image data and emptied at a rate that is comparatively slow. While the buffer is being emptied, other modules and devices may access the memory 40. But when the display pipe 46 starts getting near empty, it is rapidly refilled at the MCLK rate. By using the display pipe 46 to transfer data to the display device 32, the display device is never starved of image data.

While the display pipe 46 has been described in some detail, the reader should appreciate that the display pipe 46 is an exemplary buffer which illustrates the problem solved by the invention. The problem may occur with any type of buffer. Accordingly, the invention should not be viewed as limited to the display pipe 46, a FIFO memory, or any other particular type of buffer.

The graphics controller 38 includes a vertical enlarger 44 for expanding an image vertically. The vertical enlarger 44 is coupled to the memory controller 42. Pixel data are fetched from the memory 40 and written to the display pipe 46 one row at a time. The vertical enlarger 44 specifies which rows of image data are to be fetched from the memory and written to the display pipe. The vertical enlarger 44 expands an image vertically by causing particular rows to be fetched more than once. In addition, the vertical enlarger 44 crops an image vertically by causing particular rows not to be fetched. In other words, the vertical enlarger 44 causes certain rows to be cropped and others to be replicated in the displayed image. The vertical enlarger 44 may employ a vertical scaling circuit and a row counter to determine which rows to fetch from the memory 40.

The graphics controller 38 includes a horizontal enlarger 48 for expanding an image horizontally. The horizontal enlarger 48 is coupled to the display pipe 46 and to the display device 32 (or to a module or circuitry which interfaces to the display device 32, such as an LCD interface). Pixel data are fetched from the display pipe 46 one pixel at a time and written to the display device 32. The horizontal enlarger 48 specifies which pixels are to be transferred from the display pipe to the display device. The horizontal enlarger 48 expands an image horizontally by causing particular pixels to be transferred more than once. In addition, the horizontal enlarger 48 crops an image horizontally by causing particular pixels not to be transferred. In other words, the horizontal enlarger 48 causes certain pixels to be cropped and others to be replicated. The horizontal enlarger 48 may employ a horizontal scaling circuit and a column counter to determine which pixels to transfer from the display pipe to the display device.

Two examples illustrate how the vertical and horizontal enlargers 44, 48 enlarge an image. The examples assume that the image 20 is stored in the memory 40.

As a first example, the image 20 is displayed on the display screen 34 in its original size without enlargement. The display space, in this example, is the entire display screen 34. The vertical enlarger 44 directs image data to be fetched from the memory 40, one row at a time, beginning with row 0 and continuing to row 7 and written to the display pipe 46. All of the pixels in each row are fetched and written to the display pipe 46. The horizontal enlarger 48 directs pixels to be transferred from the display pipe 46, one pixel at a time, beginning with the pixel in column 0 and continuing to the pixel in column 7, and written to the display device 32. For each row, the horizontal enlarger 48 directs pixels transfers in an identical manner.

Operationally, the vertical enlarger 44 initializes its row counter to zero. After each row is fetched, the vertical enlarger 44 increments its row counter. The incremented row count is compared to the number of the last row in the image 20. If the row count is less than 8, the next row is fetched; if the row count equals 8, the last row has been fetched.

Operationally, the horizontal enlarger 48 initializes its column counter to zero. After each pixel is transferred from the display pipe 46 to the display device 32, the horizontal enlarger 48 increments its column counter. The incremented column count is compared to the number of the last column in the image 20. If the column count is less than 8, the next pixel is transferred; if the column count equals 8, the last pixel in the row has been transferred to the display. When the last pixel in the row has been transferred, the horizontal enlarger 48 resets its column counter, and with the next PCLK begins transferring the next row. The horizontal enlarger 48 causes all of the pixels in each row stored in the display pipe 46 to be sequentially transferred to the display device 32.

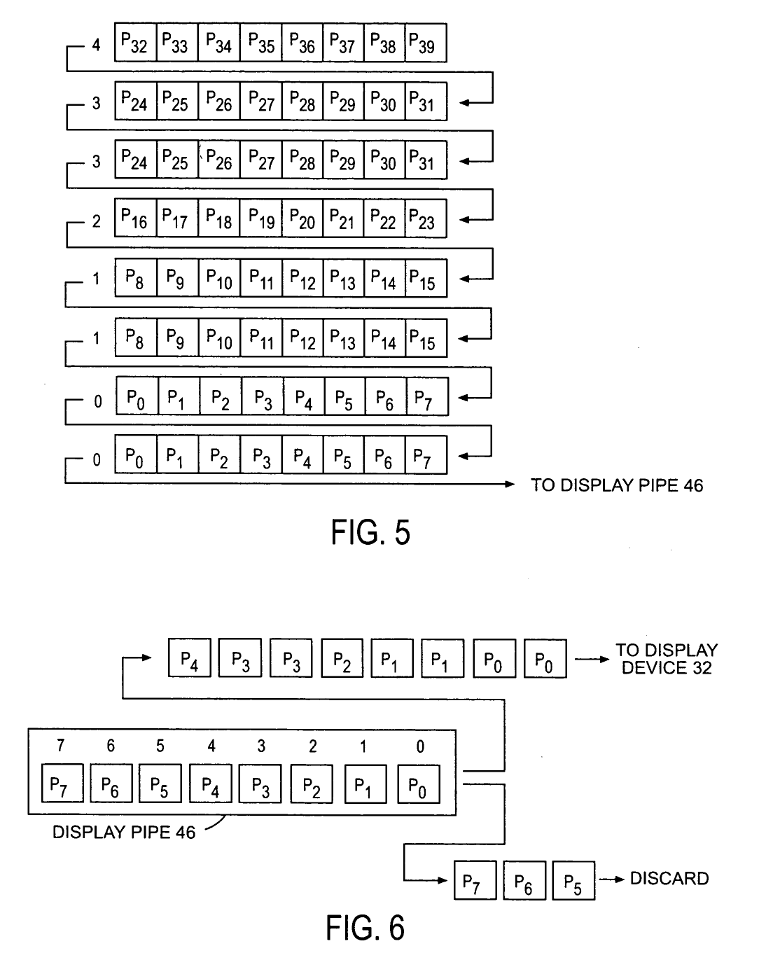

As a second example, a portion of the image 20 is selected and enlarged by 1.5× for display on the display screen 34, creating an enlarged image 50. Aspects of the second example are illustrated in FIGS. 5-7. The display space, in this second example, is again the entire display screen 34. As with the first example, the vertical enlarger 44 directs image data to be fetched from the memory 40, one row at a time, and written to the display pipe 46. Again all of the pixels in each row are fetched and written to the display pipe 46. The vertical enlarger 44, however, does not begin with row 0 and continue to row 7. Moreover, the horizontal enlarger 48 does not transfer every pixel in the display pipe 46 to the display device 32.

The reason the vertical enlarger 44 does not fetch rows 0 to 7 and the horizontal enlarger 48 does not transfer every pixel in the display pipe is because the image 20 and the display screen 34 are both 8×8 matrices of pixels. Enlarging the image by 1.5× produces a 12×12 matrix. A 12×12 matrix will not fit in the maximum 8×8 display space of the display screen 34. Thus, only a selected portion of the original image 20 may be rendered as an enlarged image on the display screen 34.

When an image is enlarged by expanding original image data by an integral amount, every row and column is replicated the same number of times. FIG. 2 is an example enlarging an image by an integral amount, that is, 2×. When an image is enlarged by expanding original image data by a non-integral or fractional amount, every row and column is not replicated the same number of times. For example, if an original image is enlarged by 1.5×, half the rows appear twice and half appear once in the enlarged image. Different scaling algorithms may identify different rows and columns for replication. The vertical enlarger 44 and horizontal enlarger 48 may employ any suitable scaling algorithm, which may be integral or fractional. The details of how a particular scaling algorithm selects rows and columns for replication is not critical to understanding the invention. For this reason, in this specification, examples which include a selection of rows or columns present rows or columns which result from the application of an exemplary scaling algorithm.

Given that some rows of the image 20 will not appear in the enlarged image 50, the vertical enlarger 44 initializes its row counter to the row number of the first row to appear in the enlarged image 50. The row number of the first row to appear in the enlarged image 50 is used to determine the first row to fetch from the memory 40. If the first row of the original image 20 is not the same as the first row of the enlarged image 50, the lower numbered rows are not fetched. For example, if the first row is row 2, rows 0 and 1 are not fetched. The vertical scaling circuit determines whether a fetched row is to be replicated, that is, fetched more than once. After each row is fetched, the vertical enlarger 44 increments its row counter. The incremented row count, however, is not compared to the number of the last row in the image 20. Instead, it is compared to the last row in the eight-row display space. If the row count is less than 8, the next row is fetched; if the row count equals 8, the last row has been fetched. The last row fetched may not be the last row in the image 20; in this case, the higher numbered rows are not fetched from memory.

Similarly, given that some columns of pixels will not appear in the enlarged image, the horizontal enlarger 48 initializes its column counter to the column number of the first column to appear in the enlarged image 50. The column number of the first column to appear in the enlarged image 50 is used to determine the first pixel to transfer from the display pipe 46. If the first column of the original image 20 is not the same as the first column of the enlarged image 50, the pixels in the lower numbered columns are not transferred. The horizontal scaling circuit determines whether a transferred pixel is to be replicated, that is, transferred more than once. After each pixel is transferred, the horizontal enlarger 48 increments its column counter. The incremented column count, however, is not compared to the number of the last column in the image 20. Instead, it is compared to the last column in the eight-row display space. If the column count is less than 8, the pixel for the next column is fetched; if the column count equals 8, the last pixel in the row has been transferred to the display device 32. The last pixel transferred may not be the last pixel in the row of the image 20; in this case, pixels in the higher numbered columns are not transferred from the display pipe to the display. The horizontal enlarger 48 resets its column counter and with the next PCLK begins transferring the next row. Pixels in columns that are not transferred to the display device are effectively discarded.

FIGS. 5 to 7 illustrate the second example. The portion of an image selected for enlargement must be defined in some way. It is typically defined by a corner pixel, though it may be defined in other ways. For instance, the corner pixel is P₁₈ (2, 2) in FIG. 2. In FIG. 5, assume that the selected portion is the upper left-hand corner of the image 20 and thus, the corner pixel is P₀ (0, 0) in the second example.

FIG. 5 shows the rows fetched by the vertical enlarger 44 in this example. As mentioned, the original image in this example is enlarged by a scale factor of 1.5×. The vertical enlarger 44, when expanding the selected portion of the image 20 by 1.5× and beginning with row 0, causes the rows 0, 1, and 3 to be fetched from memory 40 and written to the display pipe 46 twice. Further, the vertical enlarger 44 causes the rows 2 and 4 to be fetched and written once. In addition, the vertical enlarger 44 does not fetch and transfer rows 5 to 7, cropping these rows from the image 20.

FIG. 6 shows the columns fetched by the horizontal enlarger 48 in this example. The horizontal enlarger 48, when expanding the selected portion of the image 20 by 1.5× and beginning with column 0, causes the pixels in columns 0, 1, and 3 to be transferred to the display device 32 twice. Further, the horizontal enlarger 48 causes the pixels in columns 2 and 4 to be fetched and transferred once. In addition, horizontal enlarger 48 does not fetch and transfer the pixels in columns 5 to 7, cropping these pixels from the image 20. FIG. 6 only shows the transfer and discarding of pixels for the row 0. Pixels for the other rows written to the display pipe 46 are replicated, transferred, or discarded in the same manner.

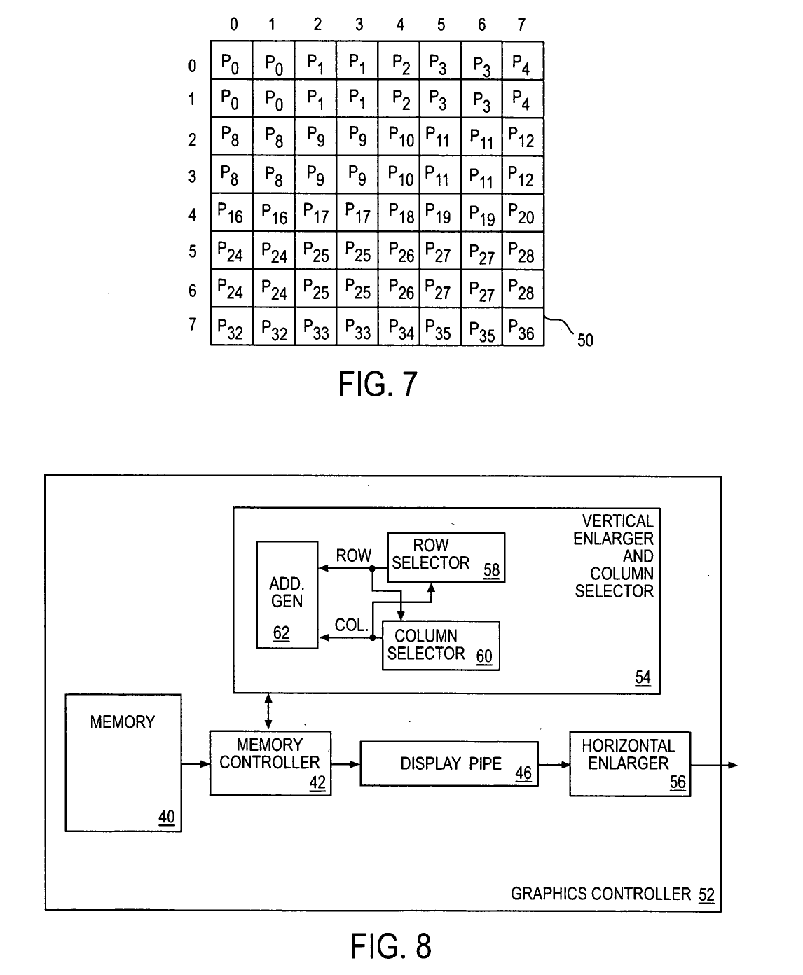

FIG. 7 shows the enlarged image 50.

An advantage of the graphics controller 38 is that the selected portion of the image 20 is horizontally enlarged after the image data has been fetched from the memory 40 and written to the display pipe 46. If the image data were to be horizontally expanded before being written to the display pipe 46, replicated pixels would be fetched from and written to the display pipe 46, inefficiently increasing the number of memory fetches and display pipe writes.

However, horizontally enlarging the image data after it has written to the display pipe 46 creates a problem. All of the pixels in each row are fetched from the memory 40 and written to the display pipe 46. Some of these pixels will ultimately be discarded by the horizontal enlarger 48 because they fall within a column that lies outside of the display space. Nevertheless, all pixels are fetched from the memory 40 and buffered in the display pipe 46. This increases the number of memory fetches and display pipe writes. In the above example, as shown in FIG. 6, three out of eight pixels in each row are discarded. In other words, for each row over 37 percent of the fetches from the memory 40 and writes to the display pipe 46 are wasted. Of the 64 pixels fetched from memory in FIG. 5, twenty-four of the pixels need not have been fetched.

The inventor has recognized this problem and has conceived an invention that solves the problem with a vertical enlarger that does not fetch pixels from the memory 40 that are in columns that will not be displayed. As a result, memory fetches are reduced, and pixels that are not fetched are not buffered in the display pipe 46. This reduces the consumption of memory bandwidth and power when writing data to a buffer during the process of creating an enlarged image.

FIG. 8 is a block diagram of a graphics controller 52 according to the invention. The graphics controller 52 includes the memory 40, memory controller 42, and display pipe 46. As mentioned, like numbered blocks refer to the same or like blocks in this specification. However, in place of the vertical enlarger 44, the graphics controller 52 has a vertical enlarger and column selector 54 (“enlarger/selector”) according to the invention. Further, in place of the horizontal enlarger 48, the graphics controller 52 has a horizontal enlarger 56 according to the invention.

The graphics controller 52 functions in a similar manner to the graphics controller 38. The enlarger/selector 54, however, operates differently from the vertical enlarger 44 (FIG. 4) in one important respect. When the vertical enlarger 44 specifies a row, it fetches all of the pixels in the row from the memory 40. On the other hand, the enlarger/selector 54 advantageously does not fetch all of the pixels in a row.

The enlarger/selector 54 is coupled to the memory controller 42 and includes a row selector module 58, a column selector module 60, and an address generator module 62. The row selector 58 and the column selector 60 are coupled to each other and each are coupled to the address generator 62.

The address generating circuit 62 responds to signals from the modules 58 and 60 by generating memory addresses. As mentioned, pixel locations in an image or a display space are defined by a column and row. For a particular pixel, the row selector 58 specifies the row and the column selector 60 specifies the column. From these row and column coordinates, the address generator 62 is adapted to determine the memory address of the pixel. The address generator 62 provides the memory address of the pixel to the memory controller 42, together with signals instructing that the pixel be fetched from the memory 40 and written to the display pipe 46.

The row selector 58 preferably includes a vertical scaling circuit and a row counter to determine which rows are to be fetched from the memory 40 and written to the display pipe 46. The row selector 58 expands and crops an image vertically in a manner similar to that described above with respect to the vertical enlarger 44. As with the vertical enlarger 44, pixel data are fetched from the memory 40 and written to the display pipe 46 one row at a time, with the row selector 58 expanding the image vertically by causing particular rows to be fetched more than once. In addition, the row selector 58 crops an image vertically by causing particular rows not to be fetched.

The column selector 60 crops an image horizontally by causing pixels located in particular columns of an image not to be fetched. For a specified scale factor, the column selector 60 precomputes whether a particular pixel or a particular set of pixels will fall outside of a horizontal display space. The scale factor may be an integer or a non-integer value. The horizontal display space may be the entire display screen 34, or a portion of the display screen.

A pixel which falls within the horizontal display space is referred to in this specification as a “display pixel.” And a pixel which falls outside of the horizontal display space is referred to in this specification as a “non-display pixel.” FIG. 10 illustrates the terms display and non-display pixel. FIG. 10 shows the image 20 with a vertical dashed line separating display and non-display pixels. The selection of display pixels in FIG. 10 is made according to the example described above with reference to FIGS. 5-7. For instance, FIG. 6 shows the pixels in columns 5, 6, and 7 being discarded, and in FIG. 10, the pixels in columns 5, 6, and 7 are designated as non-display pixels.

Using these terms, column selector circuit 60 precomputes whether a particular pixel is a display or non-display pixel. Instead of fetching an entire row of the image data from the memory 40, the enlarger/selector 54 only fetches display pixels from memory and only writes display pixels to the display pipe 46.

To cause the column selector 60 to begin selecting display pixels for a particular row, a new row signal is asserted. Preferably, the row selector 58 provides the column selector 60 with a new row signal each time it selects a row. The column selector 60 responds to the new row signal by selecting the pixel in the first column of the selected portion and providing this first column number to the address generator 62.

Preferably, the column selector 60 is a synchronous circuit. After the column selector 60 sends the first column number to the address generator 62, the new row signal is de-asserted. Subsequently, each time the column selector 60 is clocked, it sends a new column number to the address generator 62 until it has sent the column number for the last display pixel. When the last column number has been sent, the column selector provides a signal to the row selector 58, signaling that the end of the row has been reached.

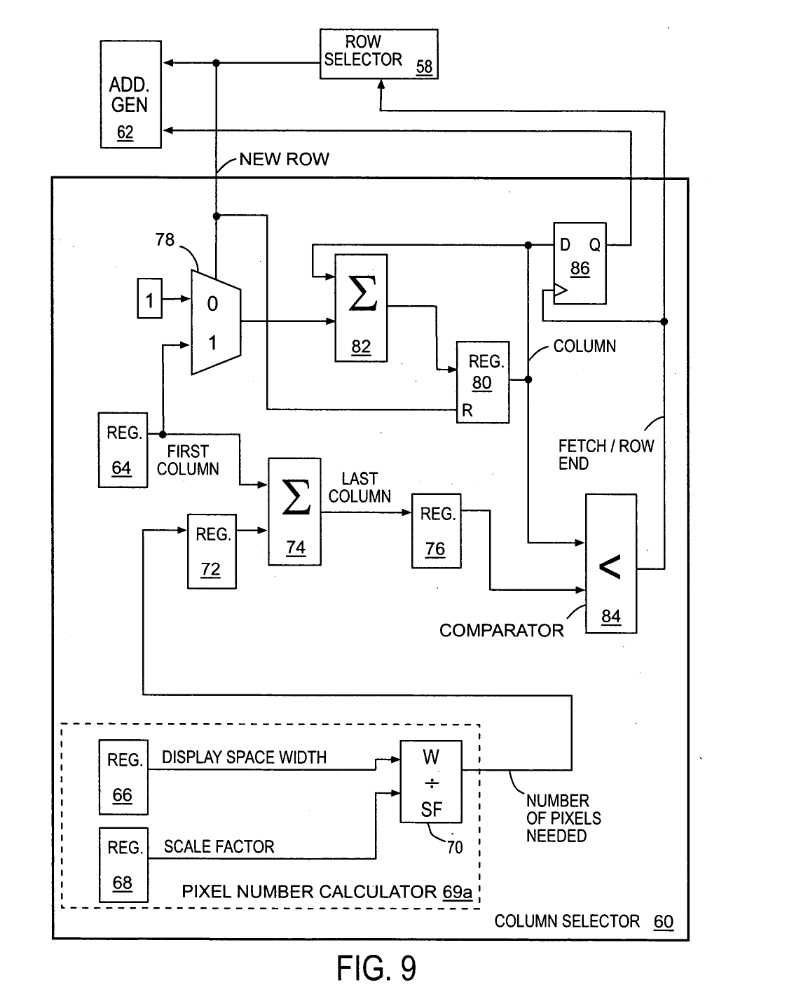

FIG. 9 illustrates one preferred embodiment of the column selector circuit 60. The column selector circuit 60 includes a register 64 for storing the column of the first pixel of the image portion selected for enlargement, a register 66 for storing the width of the display space, and a register 68 for storing the scale factor. The column of the first pixel, the display space width, and the scale factor are variable. The appropriate parameters for the desired enlarging operation are stored in the registers 64, 66, and 68 by the host 28, the image capture device 36, a module or other logic within the graphics controller, or some other device.

The registers 66 and 68 are coupled to a divider circuit 70. The registers 66, 68 and the divider circuit 70 together comprise a pixel number calculator 69a. The display space width (“W”) when divided by the scale factor (“SF”) gives the number of pixels from the original image that will appear in the enlarged image. This quotient may or may not be an integer. To ensure that all of the pixels that will appear in the enlarged image are fetched memory, the quotient is preferably rounded up to an integer. The divider circuit 70 divides the display space width by the scale factor, rounds up the quotient, and stores it in a register 72.

The quotient stored in register 72 is the number of pixels that need to be fetched from the memory 40. To determine which columns the display pixels are located in, the number of pixels needed is added to the column number of the first pixel in the selected portion, which is stored in register 64. As mentioned, a corner pixel is typically employed to identify the selected portion. The column coordinate of the corner pixel may be stored in the register 64. The column selector 60 includes an adder 74 to add the number of needed pixels and the first column.

The inputs of the adder 74 are coupled to the registers 64 and 72. The output of the adder 74 is the column number of the last display pixel in the selected portion of the image. The output of the adder 74 is coupled to a register 76. The last column number is stored in register 76.

The column selector 60 receives the new row signal each time a new row is specified to the address generator 62. The new row signal is coupled to the select input of a multiplexer 78 and to a reset input of a register 80. The multiplexer 78 selects one of two inputs. A first input is coupled to the numeric value one. The second input is coupled to the register 64, which holds the column number of the first pixel in the selected portion.

When the new row signal is asserted, the multiplexer 78 selects its second input and transfers the first column number to its output. In addition, when the new row signal is asserted, the contents of the register 80 are reset to zero. When the new row signal is de-asserted, the multiplexer 78 selects its first input, which transfers a “1” to the output of the multiplexer 78.

The column selector circuit 60 also includes an adder 82. The adder 82 sums its own output and the output of the multiplexer 78. The sum is a column number which is stored in the register 80.

As mentioned, the contents of the register 80 are reset to zero when the new row signal is asserted. Thus, when the new row signal is asserted, the first column number is added to the zero stored in register 80, producing a sum equal to the first column number. Thus, the new row signal stores the first column number in the register 80. On the next clock cycle, the new row signal is de-asserted, the multiplexer 78 selects its first input, and the adder 82 sums the first column number plus one. On each subsequent clock cycle, the adder 82 increments the column number by one, storing the result in register 80.

The output of the register 80 is coupled to a comparator 84. In addition, the output of the register 76 is coupled to the comparator 84. The column number in register 80 and the last column number in register 76 are compared by the comparator 84. If the column number is less than the last column number, a fetch/row end signal is asserted. (Use of the fetch/row end signal is explained below.) For the pixel in the first column, the fetch/row end signal will be asserted (because the first column is less than the last column). Each time the column number in register 80 is incremented, a comparison is made, and if the column defines the location of one of the display pixels, the fetch/row end signal is asserted. On the other hand, as soon as the column in register 80 defines the location of a non-display pixel, the fetch/row end signal is de-asserted.

The fetch/row end signal is provided to the row selector 58 and a register 86. The data input of the register 86 is coupled to the output of the register 80, which stores a column number. The fetch/row end signal is coupled to the clock input of the register 86. Thus, when the fetch/row end signal is asserted, the column number in register 80 is transferred to the Q output of the register 86. The Q output of the register 86 is coupled to the address generator 62. Accordingly, when the fetch/row end signal is asserted, a column number is provided to the address generator 62.

If the comparison by comparator 84 indicates that the column contains a display pixel, the fetch/row end signal is asserted and that column number is provided to the address generator 62. On the other hand, if the comparison by comparator 84 indicates that the column contains a non-display pixel, the fetch/row end signal is de-asserted and the column number on the D input of the register 86 is not transferred to the Q output, nor to the address generator 62.

In addition, if the comparison by comparator 84 indicates that the column contains a non-display pixel, the row selector 58 responds to the de-assertion of the fetch/row end signal by providing a new row number to the address generator 62, or if it has selected all of the rows, ending the row selection process.

Referring again to FIG. 8, as mentioned, the graphics controller 52 includes a horizontal enlarger 56 for expanding an image horizontally. The horizontal enlarger 56 is coupled to the display pipe 46 and to the display device 32 (or to a module or circuitry which interfaces to the display device 32, such as an LCD interface). Pixel data are fetched from the display pipe 46 one pixel at a time and written to the display device 32. The horizontal enlarger 56 specifies the number of times pixels are to be transferred from the display pipe to the display device. The horizontal enlarger 56 expands an image horizontally by causing particular pixels to be transferred more than once. The horizontal enlarger 48 may employ a horizontal scaling circuit for this purpose. Unlike the horizontal enlarger 48, the horizontal enlarger 56 does not have the capability to crop an image horizontally by causing particular pixels not to be transferred. The horizontal enlarger 56 is thus simpler, consumes less power, and consumes less physical space than the horizontal enlarger 48.

In summary, the graphics controller 52 includes a novel apparatus for writing data to a buffer, such as the display pipe 46, when creating an enlarged image. The only pixels the enlarger/selector 54 of the graphics controller 52 causes to be fetched from the memory 40 and written to the display pipe 46 are the display pixels. The enlarger/selector 54 employs the novel column selector 60 to compute whether the pixel in a particular column is a display or non-display pixel. This computation is performed before the image is horizontally scaled and before image data is fetched from memory.

The enlarger/selector 54 and column selector 60 are one preferred embodiment. Other modules and circuits, consistent with the principles of the invention, may be employed for causing only display pixels to be fetched from the memory 40 and written to the display pipe 46.

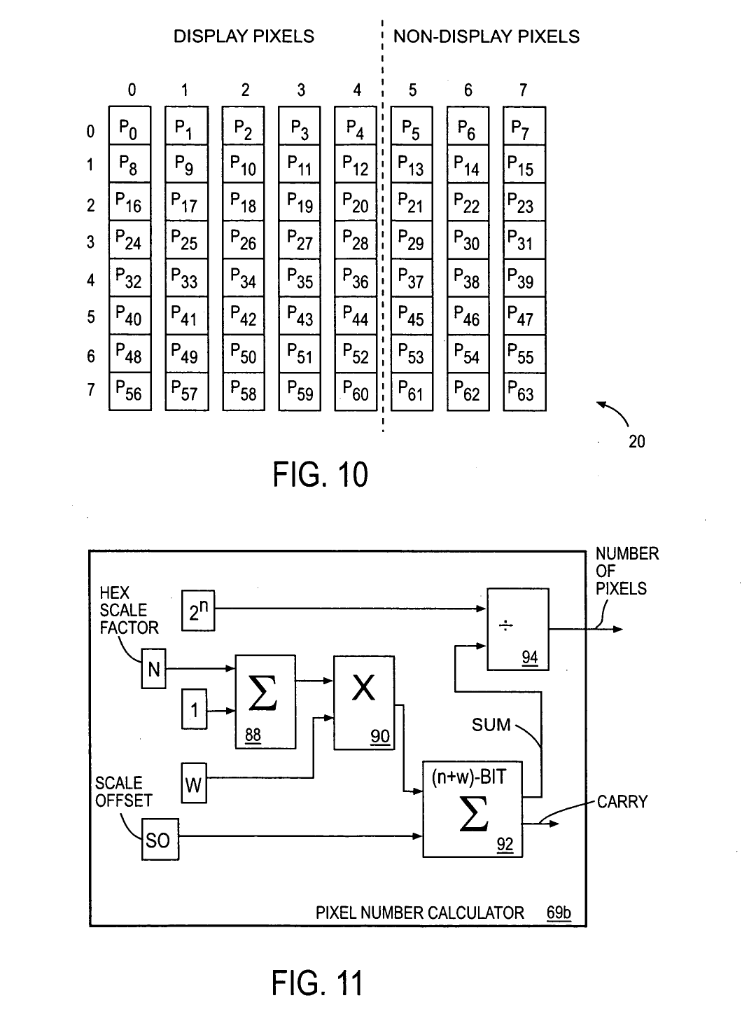

FIG. 11 illustrates one alternative preferred embodiment of the pixel number calculator 69a portion of the column selector 60. FIG. 11 is a block diagram of a pixel number calculator 69b for determining the number of pixels needed to be fetched from the memory 40. The pixel number calculator 69b is suited for use with a fractional zoom enlarger, that is, an enlarger capable of enlarging an image by 10.5×, 1.6×, and so on. The pixel number calculator 69b may be substituted for the pixel number calculator 69a.

The pixel number calculator 69b evaluates the expression:
Number of Pixels to Fetch=((W×(1+N))+SO)/2ⁿ
If the result is not an integer, it is rounded up. In this expression, “W” is the width of the display space, “N” is a hexadecimal (“hex”) scale factor, “SO” is a scale offset value, and n is the number of bits needed to represent the maximum hex scale factor N that an associated image enlarging circuit can accept. The scale offset SO is a user-supplied parameter for specifying the number of times the first pixel of the selected portion of the original image will be reproduced in the enlarged image.

The pixel number calculator 69b employs a first adder 88 for adding the hex scale factor N to the number one. The hex scale factor N is related to the scale factor referred to above by the relation: N=(2ⁿ/scale factor)−1. For example, if the maximum scale factor the image enlarging circuit can accept is 256×(255d=1111 1111b), then n=8. To enlarge an image by 32×, the corresponding hex scale factor is: N=(2⁸/32)−1=07h.

A multiplier 90 multiplies the sum the adder 88 generates by the display space width W. For instance, if the enlarged image will be 128 pixels wide, W is 128. The product of the multiplication is coupled to a second adder 92, which sums the product and the scale offset value SO. The adder 92 is a (n+w) bit adder, where w is the number of bits needed to represent W. If W=128 (1000 0000b), for example, then w=8, as eight bits are required to represent W. Thus, if the maximum scale factor the image enlarging circuit can accept is 256× and the display space width W=128, then n+w=8+8=16, requiring the adder 92 to be a 16-bit adder.

The sum that the adder 92 outputs is coupled to a divider 94. The divider 94 divides the of output adder 92 by 2ⁿ. The quotient that divider 94 outputs is the number of pixels that need to be fetched from memory 40. Alternatively, an n-bit shifter may be substituted for the divider 94. The shifter shifts the output of the adder 92 n bits to the right.

To illustrate operation of the pixel number calculator 69b, assume that the scale offset SO=0. Assume that the maximum scale factor is 256×, the image is to be enlarged by 32×, and displayed in a display space 128 pixels wide. For 32×, N=07h. Thus,
Number of Pixels to Fetch=((W×(1+N))+SO)/2ⁿ
Number of Pixels to Fetch=((128×(1+7))+0)/256=4

This result is as expected, because multiplying each of the four pixels 32 times yields the display space of 128 (4×32=128).

As described in this specification, the graphics controllers 38 and 52 include only a single display pipe 46 for buffering image data. The reason that only a single display pipe is shown is to simplify the explanation in this specification. A graphics controller, including the graphics controllers 38 and 52, may include additional display pipes, such as a display pipe for each of several windows that may be simultaneously displayed on the display screen 34. For example, one display pipe may be used for image data received from the host 28 as a main image and another display pipe may be used to display image data received from the image capture device 36 for an overlay image, which overlays the main image.

The invention also includes a method for selecting pixels to write to a buffer when creating an enlarged image. The method includes the steps of:
Determining which rows of pixels in an original image are non-display rows.
Expanding the original image vertically, by selecting at least one of the display rows for inclusion in the enlarged image more than once.
Determining which pixels in a row of pixels are non-display pixels.
Fetching the display pixels in a display row of pixels from a memory.
Forwarding the display pixels in a display row of pixels for rendering in a display space so that the non-display pixels in the row are not forwarded for rendering in the display space.
Expanding the original image horizontally, by selecting at least one of the pixels in a row for inclusion in the enlarged image more than once.

The step of determining which pixels in a row of pixels are non-display pixels preferably includes determining a first display pixel in the row of pixels and a quantity of display pixels in a row of pixels. The step of forwarding the display pixels in a display row of pixels for rendering in a display space may include writing the display pixels to a buffer, such as a display pipe. In addition, the step of expanding the original image horizontally may include transmitting pixels to an image rendering device.

The invention is also directed to a machine readable medium, such as magnetic or optical disks, hard disk drives, memory chips, and other similar memory devices. The medium embodies a program of instructions that may be executed by a machine, such as a computer system. The program of instructions may be software, firmware, hardware code, or other similar program. When the machine executes the program, it performs a method in accordance with the principles of the invention, such as the preferred method described above.

The invention has been illustrated with graphics controller having an embedded memory 40. The principles of the invention may be practiced in any digital device. Moreover, the memory 40 or the display pipe 46 need not be located on the same integrated circuit as the column selector 60.

The invention has been illustrated with an original image stored in the memory 40. In other embodiments, the principles of the invention may be applied to streaming image data not stored in a memory. For example, in one embodiment for expanding streaming image data, a row of image data is provided to the enlarger/selector 54, appropriately modified, and columns are selected for writing the pixels in selected columns to the display pipe 46. This embodiment may only enable the horizontal expansion of an image. The reason is that the display pipe 46 may not have the capacity to store a full row of pixels. Vertical expansion would be possible only if the display pipe 46, in this embodiment, has the capacity to store at least one full row of pixels. While this embodiment may not save bandwidth of the memory 40 it still provides the significant advantage of not writing non-display pixels to the display pipe.

The terms and expressions that have been employed in the foregoing specification are used as terms of description and not of limitation, and are not intended to exclude equivalents of the features shown and described or portions of them. The scope of the invention is defined and limited only by the claims that follow.

1. An apparatus for creating, from an original image, an enlarged image for rendering in a display space, the original image and the display space each being defined by a matrix of pixels, wherein the original image includes display pixels that will be rendered in the enlarged image and non-display pixels that will not be rendered in the enlarged image, the apparatus comprising:
a display pipe for buffering a row of pixels to be rendered in the display space; and
a controller for writing display pixels to the display pipe, wherein the controller is adapted for determining which pixels in a row of pixels are non-display pixels so that the controller does not write the non-display pixels to the display pipe.

2. The apparatus of claim 1, further comprising a horizontal enlarger for selecting display pixels in a row for rendering in the display space, the horizontal enlarger being adapted to horizontally enlarge a row of pixels by selecting at least one of the pixels in the row for rendering more than once.

3. The apparatus of claim 1, further comprising a row selector for selecting rows of pixels in the original image for writing to the display pipe.

4. The apparatus of claim 3, the row selector being adapted to vertically enlarge a selected portion of the original image by selecting at least one row of pixels in the original image more than once.

5. The apparatus of claim 3, the row selector being adapted to crop the original image vertically by not selecting at least one row of pixels in the original image.

6. The apparatus of claim 1, further comprising a memory for storing the original image.

7. The apparatus of claim 6, further comprising a fetching apparatus for fetching display pixels from the memory, the fetching apparatus being communicatively coupled to the controller and to the row selector.

8. The apparatus of claim 7, further comprising a horizontal enlarger for selecting display pixels in a row for rendering in the display space, the horizontal enlarger being adapted to horizontally enlarge a row of pixels by selecting at least one of the pixels in the row for rendering more than once.

9. The apparatus of claim 6, further comprising a row selector for selecting rows of pixels in the original image for writing to the display pipe.

10. The apparatus of claim 9, the row selector being adapted to vertically enlarge a selected portion of the original image by selecting at least one row of pixels in the original image more than once.

11. The apparatus of claim 10, the row selector being adapted to crop the original image vertically by not selecting at least one row of pixels in the original image.

12. A method for creating, from an original image, an enlarged image for rendering in a display space, the original image and the display space each being defined by a matrix of pixels, wherein the original image includes display pixels that will be rendered in the enlarged image and non-display pixels that will not be rendered in the enlarged image, the method comprising:
determining which pixels in a row of pixels are non-display pixels; and
forwarding the display pixels for rendering in the display space so that the non-display pixels are not forwarded for rendering in the display space.

13. The method of claim 12, further comprising determining which rows of pixels in the original image are non-display rows.

14. The method of claim 13, further comprising expanding the original image vertically by selecting at least one of the display rows of pixels in the original image for inclusion in the enlarged image more than once.

15. The method of claim 12, further comprising fetching the display pixels in a row from a memory.

16. The method of claim 12, wherein the step of forwarding the display pixels for rendering further comprises writing only the display pixels to a buffer.

17. The method of claim 12, further comprising the step of selecting at least one of the pixels in a row for inclusion in the enlarged image more than once.

18. The method of claim 17, further comprising transmitting the selected at least one of the pixels to an image rendering device more than once.

19. The method of claim 12, the step of determining which pixels in a row of pixels are non-display pixels further comprising determining a first display pixel in a row of pixels and a quantity of display pixels in a row of pixels.

20. An system for creating, from an original image, an enlarged image for rendering in a display space, the original image and the display space each being defined by a matrix of pixels, wherein the original image includes display pixels that will be rendered in the enlarged image and non-display pixels that will not be rendered in the enlarged image, the system comprising:
a host processor;
a display device;
a graphics controller, the graphics controller comprising:
a display pipe for buffering a row of pixels to be rendered in the display space; and
a controller for writing display pixels to the display pipe, wherein the controller is adapted for determining which pixels in a row of pixels are non-display pixels so that the controller does not write the non-display pixels to the display pipe.

21. The system of claim 20, further comprising a horizontal enlarger for selecting display pixels in a row for rendering in the display space, the horizontal enlarger being adapted to horizontally enlarge a row of pixels by selecting at least one of the pixels in the row for rendering more than once.

22. The system of claim 20, further comprising a row selector for selecting rows of pixels in the original image for writing to the display pipe.

23. The system of claim 22, the row selector being adapted to vertically enlarge a selected portion of the original image by selecting at least one row of pixels in the original image more than once.

24. The system of claim 22, the row selector being adapted to crop the original image vertically by not selecting at least one row of pixels in the original image.

25. The system of claim 20, further comprising a memory for storing the original image.

26. The system of claim 25, further comprising a fetching system for fetching display pixels from the memory, the fetching system being communicatively coupled to the controller and to the row selector.

27. The system of claim 26, further comprising a horizontal enlarger for selecting display pixels in a row for rendering in the display space, the horizontal enlarger being adapted to horizontally enlarge a row of pixels by selecting at least one of the pixels in the row for rendering more than once.

28. The system of claim 25, further comprising a row selector for selecting rows of pixels in the original image for writing to the display pipe.

29. The system of claim 28, the row selector being adapted to vertically enlarge a selected portion of the original image by selecting at least one row of pixels in the original image more than once.

30. The system of claim 29, the row selector being adapted to crop the original image vertically by not selecting at least one row of pixels in the original image.

31. A machine-readable medium embodying a program of instructions executable by a machine to perform a method for creating, from an original image, an enlarged image for rendering in a display space, the original image and the display space each being defined by a matrix of pixels, wherein the original image includes display pixels that will be rendered in the enlarged image and non-display pixels that will not be rendered in the enlarged image, the method comprising:
determining which pixels in a row of pixels are non-display pixels; and
forwarding the display pixels for rendering in the display space so that the non-display pixels are not forwarded for rendering in the display space.

32. The medium of claim 31, further comprising determining which rows of pixels in the original image are non-display rows.

33. The medium of claim 32, further comprising expanding the original image vertically by selecting at least one of the display rows of pixels in the original image for inclusion in the enlarged image more than once.

34. The medium of claim 31, further comprising fetching the display pixels in a row from a memory.

35. The medium of claim 31, wherein the step of forwarding the display pixels for rendering further comprises writing only the display pixels to a buffer.

36. The medium of claim 31, further comprising the step of selecting at least one of the pixels in a row for inclusion in the enlarged image more than once.

37. The medium of claim 36, further comprising transmitting the selected at least one of the pixels to an image rendering device more than once.

38. The medium of claim 31, the step of determining which pixels in a row of pixels are non-display pixels further comprising determining a first display pixel in a row of pixels and a quantity of display pixels in a row of pixels.
